(19) United States
(12) Patent Application Publication
(10) Pub. No.: US 2014/0060612 A1
(43) Pub. Date: Mar. 6, 2014

(54) PHOTOVOLTAIC CELL

(71) Applicants: Davide DiCenso, Evian les Bains (FR); John Meschter, Saint-Sulpice (GB)

(72) Inventors: Davide DiCenso, Evian les Bains (FR); John Meschter, Saint-Sulpice (GB)

(73) Assignee: G24i Power Limited, Cardiff (GB)

(21) Appl. No.: 14/002,803

(22) PCT Filed: Mar. 5, 2012
(86) PCT No.: PCT/GB2012/050477

§ 371 Date: Nov. 13, 2013

(30) Foreign Application Priority Data
Mar. 4, 2011 (GB) 1103810.6

(51) Int. Cl. H01G 9/20; H01G 9/00

(52) U.S. Cl. CPC H01G 9/2059; H01G 9/0029
USPC 136/244; 136/256; 438/57

(57) ABSTRACT

A dye-sensitised photovoltaic cell is provided, the cell comprising a first, transparent, electrode facing a second electrode, wherein at least one of the first and second electrodes is provided with an electrically-conductive material comprising (A) one or both of nickel and cobalt, and (B) one or more of phosphorous, boron, manganese, iron, tungsten, molybdenum, chromium, tin, zinc and palladium, wherein the total content of (A) the nickel and cobalt in said electrically-conductive material is from 80 to 96 wt % of the electrically-conductive material, and total content of (B) the phosphorous, boron, manganese, iron, tungsten, molybdenum, chromium, tin, zinc and palladium in said electrically-conductive material is from 4 to 20 wt % of the electrically-conductive material.

The present invention relates to a dye-sensitised photovoltaic cell, arrays of such photovoltaic cells, electrodes for use in dye-sensitised photovoltaic cells and methods of making electrodes for dye-sensitised photovoltaic cells.

Dye-sensitised photovoltaic cells are well-known to those skilled in the art, and were first described by Grätzel. The cells typically comprise two electrodes, being an anode and a cathode, which contact an electrolyte,. Each of these electrodes is provided with an electrically-conductive material (usually in the form of a layer) which typically contacts the electrolyte. The electrically-conductive material is often prone to corrosion by the electrolyte, in which case the life time of the cell may be limited.

The present invention seeks to provide a cell which is less susceptible to corrosion of parts of the electrodes.

In accordance with a first aspect of the present invention, there is provided a dye-sensitised photovoltaic cell comprising a first, transparent, electrode facing a second electrode, wherein at least one of the first and second electrodes is provided with an electrically-conductive material comprising (A) one or both of nickel and cobalt, and (B) one or more of phosphorous, boron, manganese, iron, tungsten, molybdenum, chromium, tin, zinc and palladium. The total content of (A) the nickel and cobalt in said electrically-conductive material is from 80 to 96 wt % of the electrically-conductive material, and total content of (B) the phosphorous, boron, manganese, iron, tungsten, molybdenum, chromium, tin, zinc and palladium in said electrically-conductive material is from 4 to 20 wt % of the electrically-conductive material.

Typically, the first electrode is an anode and the second electrode is a cathode.

For the avoidance of doubt, it is hereby stated that components (A) and (B) are mixed. Whilst not wishing to be bound by theory, it is believed that the components (A) and (B) are an alloy in some embodiments.

For the avoidance of doubt, the term “transparent”, as used in this specification, is to be taken as having a relatively broad meaning that light is able to pass through. Preferably the light passes through without significant change to one or both of its intensity and wavelength(s), but it is within the scope of the invention for there to be such changes. Thus, a transparent electrode permits light to pass therethrough, for example, so that light may impinge on dye placed in the cell. Transparency of an electrode may be achieved by making the electrode from intrinsically light-transmissive materials or by providing light-transmissive apertures in materials which are not intrinsically transparent.

The wt % of the electrically-conductive material which is not nickel, cobalt, phosphorous, boron, manganese, iron, tungsten, molybdenum, chromium, tin, zinc or palladium is typically from 0 to 2 wt % and optionally from 1 to 2 wt %.

The total content of (B) the phosphorous, boron, manganese, iron, tungsten, molybdenum, chromium, tin, zinc and palladium in said electrically-conductive material is optionally from 4 to 16 wt % of the electrically-conductive material.

The total content of (A) the nickel and cobalt in said electrically-conductive material is optionally from 84 to 96 wt % of the electrically-conductive material.

The total content of phosphorous, boron, manganese, iron, tungsten, molybdenum, chromium, tin, zinc and palladium may optionally be at least 6%, optionally at least 7 wt %, optionally at least 8 wt %, further optionally at least 9 wt %, more optionally at least 10 wt % and further more optionally at least 10.5 wt % of the electrically-conductive material. In one embodiment, component (B) is one or more of phosphorous, manganese, iron, tungsten, tin and palladium. The electrically-conductive material may optionally be amorphous, or may alternatively be crystalline. In some embodiments, it has been found that amorphous material is more resistant to corrosion by the electrolyte than crystalline material. Amorphous materials are typically formed when one or more of phosphorous or boron is present in the electrically-conductive material, especially the total content of one or more of phosphorous or boron is relatively high (for example, greater than 10 wt % of the electrically-conductive layer). The presence of substantial levels of phosphorous has been found to be particularly advantageous in providing an amorphous material having beneficial corrosion resistant properties whilst avoiding environmental concerns associated with the use of boron. The presence of one or more or manganese, iron, tungsten, molybdenum, chromium, tin, zinc and palladium has typically been found to enhance the mechanical properties of the electrically-conductive material.

Component (A) of the electrically conductive material, i.e. the one or more of nickel and cobalt, may optionally be nickel alone (no cobalt), cobalt alone (no nickel) or nickel and cobalt. In one embodiment, component (A) is nickel alone (no cobalt) or nickel and cobalt. In an alternative embodiment, component (A) is cobalt alone (no nickel).

If material comprises both nickel and cobalt, the wt % of nickel may optionally be greater than the wt % of cobalt.

The electrically-conductive material may optionally comprise only one or two of phosphorous, boron, manganese, iron, tungsten, molybdenum, chromium, tin, zinc and palladium.

The electrically-conductive material may, for example, comprise only one of phosphorous, boron, manganese, iron, tungsten, molybdenum, chromium, tin, zinc and palladium, for example, only phosphorous.

The electrically-conductive material optionally comprises phosphorous and/or boron, especially phosphorous Optionally, the electrically-conductive material comprises phosphorous and/or boron, especially phosphorous in combination with one or more of manganese, iron, tungsten, molybdenum, chromium, tin, zinc and palladium, for example, phosphorous in combination with one or more of manganese, iron, tungsten, tin and palladium.

The electrically-conductive material is typically in the form of a layer. The term “layer” as used herein refers to a thickness of said electrically conductive material, and includes (but is not limited to) a structure which is perforated (often referred to by those skilled in the art as “a grid”). The term naturally includes a thickness of material which is not perforated. The term “layer” includes (but is not limited to) a thickness of said material which is adhered or otherwise attached to other features of the cell (for example, a supporting substrate) The term “layer” includes (but is not limited to) a thickness of said material which has been deposited onto another feature of the cell. The term “layer” also includes a thickness of said material which is not attached or adhered to other features of the cell. The layer typically has a thickness of up to 200 μm. In one embodiment, the layer typically has a thickness of up to 50 nm. Layer thicknesses of up to 50 nm have been found to be sufficient for so-called “seed” layers which promote adhesion of growth or further layers thereon. In this embodiment, the layer advantageously may have a thickness of up to 20 nm. Layers of such thickness may be transparent. In one embodiment, the layer has a thickness of from 20 nm to 1000 nm. Layer thicknesses of 20 nm to 1000 nm have been found to be sufficient when the underlying electrode already possesses a degree of corrosion resistance. In another embodiment, the layer has a thickness of from 1 μm to 10 μm. Layer thicknesses of 1 μm to 10 μm have been found to be advantageous when the underlying electrode is not corrosion resistant, such as, for example, when the electrode comprises a copper-nickel mesh or a nickel underlayer. In a further embodiment, the layer has a thickness of from 10 μm to 200 μm, for example from 10 μm to 100 μm. Layer thicknesses of 10 μm to 100 μm or more, for example from 10 μm to 200 μm, have been found to be advantageous when the layer is applied as a mesh. Furthermore, layers having a thickness of from 1 μm to 200 μm provide significant in-plane conductivity.

As mentioned above, the layer of electrically-conductive material may be free-standing i.e. unattached to other parts of the cell. Alternatively, the layer of electrically-conductive material may be adhered or otherwise attached to other parts of the cell. For example, in one embodiment, the layer may be in the form of a self-supporting foil or grid of said conductive material which has been laminated to a supporting substrate.

The layer of said electrically-conductive material may, for example, be applied by electrolytic deposition, electroless deposition, vacuum deposition or printing techniques. Vacuum deposition includes (but is not limited to) evaporation (including thermal evaporation), sputtering, cathodic ion vaporisation, physical vapour depositions and chemical vapour deposition [CVD] (including low pressure CVD and plasma enhanced CVD).

It has been found that said electrically-conductive material is advantageously resistant to corrosion by an electrolyte which is typically provided between the first and second electrodes.

The photovoltaic cell is typically provided with a supported dye. The supported dye is typically attached to one of the first and second electrodes. In one embodiment, the supported dye is attached to the first electrode. In another embodiment, the supported dye is attached to the second electrode.

The electrically-conductive material is advantageously arranged to be in contact with the electrolyte, in the event that the electrolyte is present, even in the event that an overlayer is provided on the electrically-conductive material (such an overlayer, if present, typically being porous).

One or more overlayers may optionally be provided on the electrically-conductive material. The one or more overlayers may comprise a protective layer. The protective layer may inhibit reaction between the electrically-conductive material and a species with which the electrically-conductive material may react. The one or more overlayers may comprise a catalytic layer comprising a catalyst. The catalytic layer may comprise platinum or nickel sulphide catalyst, for example. If the one or more overlayers comprises a catalytic layer, then optionally a protective layer may be provided between the catalytic layer and the electrically-conductive material. For example, if the catalytic layer comprises platinum catalyst, then it may be advantageous to provide a protective layer between the platinum-containing catalytic layer and the electrically-conductive material. It has been discovered that a protective layer may inhibit the corrosion of the electrically-conductive material which may occur if the electrically-conductive material is in contact with platinum.

The protective layer may optionally have a mean thickness of from 10 nm to 5 microns, and optionally a mean thickness of from 10 to 500 nm.

The protective layer may optionally comprise one or more metals selected from the group consisting of tantalum, tungsten, zirconium, niobium, molybdenum, titanium, ruthenium, rhodium, palladium, indium, rhenium, osmium, iridium and platinum. The one or more metals selected from the group consisting of tantalum, tungsten, zirconium, niobium, molybdenum, titanium, ruthenium, rhodium, palladium, indium, rhenium, osmium, iridium and platinum may optionally make-up at least 80 wt % (and optionally at least 90 wt %) of the protective layer. Optionally, the protective layer may substantially consist of one or more metals selected from the group consisting of tantalum, tungsten, zirconium, niobium, molybdenum, titanium, ruthenium, rhodium, palladium, indium, rhenium, osmium, iridium and platinum. Such metals may be deposited by plasma vapour deposition (for example, for tantalum, tungsten, zirconium, niobium, molybdenum and titanium) and by electrochemical deposition (for example, for ruthenium, rhodium, palladium, indium, rhenium, osmium, iridium and platinum).

The protective layer may optionally comprise one or more oxides, such as metal oxides or silicon oxide. The one or more oxides may be selected from the group consisting of silicon oxide, titanium dioxide, tin dioxide and indium tin oxide.

The one or more oxides may make-up at least 80 wt % (and optionally at least 90 wt %) of the protective layer. Optionally, the protective layer may substantially consist of the one or more oxides. Such oxide protective layers may be deposited using chemical vapour deposition, such as atmospheric plasma assisted chemical vapour deposition.

The protective layer may optionally comprise one or more salts, optionally of nickel and/or cobalt, such as chromate, phosphate, molybdate, molybdophosphate, tungstate, permanganate, cerate, zirconate and sulphide. For example, optionally be protective layer comprises sulphide, such as nickel sulphide, cobalt sulphide and/or molybdenum sulphide. Sulphides may also provide an advantageous catalytic effect.

The one or more salts may make-up at least 80 wt % (and optionally at least 90 wt %) of the protective layer. Optionally, the protective layer may substantially consist of the one or more salts. Such protective layers may be formed chemically or electrolytically. For example, the protective layer may be formed on the electrically-conductive material prior to the assembly of the photovoltaic cell. Alternatively or additionally, the protective layer may be formed by providing a dye-sensitized photovoltaic cell comprising the electrically-conductive material in intimate contact with an electrolyte comprising sulphide ions and operating the photovoltaic cell. The electrically-conductive material may corrode to produce Ni²⁺ ions which react with sulphide ions to produce nickel sulphide over the electrically-conductive material.

The electrolyte, if present, typically comprises iodide electrolyte, but may be another type of electrolyte.

The second electrode may be transparent or may be reflective so as to reflect light incident on the second electrode back into the cell. Transparency of the first (and second electrode, if transparent) may be achieved by making the electrode from intrinsically transparent materials or by providing light-transmissive apertures in those materials which are not intrinsically transparent. For example, a certain thickness of said electrically-conductive material (for example, greater than 20 nm) may not be intrinsically transparent, but the provision of light-transmissive apertures in a layer of said material would make the layer transparent.

An electrode comprising the electrically-conductive material typically comprises a supporting substrate. Examples of suitable materials for the supporting substrate include glass, ceramic, plastics materials, metal (for example, brass) and dielectric oxides. The supporting substrate may optionally comprise said electrically-conductive material. In this case, the electrically-conductive material may provide support to other parts of the cell. Such a supporting substrate may be transparent (especially if the electrode is the first electrode) or may optionally be reflective (if, for example, the electrode is the second electrode). The supporting substrate may he rigid (for example, glass) or may be flexible (for example, made from a polymer). One or more layers may be provided between the supporting substrate and said electrically-conductive material. For example, an activation layer may be provided between the supporting substrate and the electrically-conductive material. The activation layer typically promotes adhesion of the electrically-conductive material to the supporting substrate. Alternatively or additionally, the supporting substrate (or one or more layers provided between the supporting substrate and the electrically-conductive material, if present) may be surface modified (for example, roughened, plasma activated or ion implanted).

Furthermore, a layer of metal may be provided between the supporting substrate and the electrically-conductive material, optionally between the activation layer (if present) and the electrically-conductive material. A layer of metal may decrease the sheet resistance of the electrode.

The electrically-conductive material may optionally be deposited using an electroless method. Alternatively, the electrically-conductive material may be deposited using an electrolytic method; such a method typically leading to a higher weight percentage of the one or more of phosphorous, boron, manganese, iron, tungsten, molybdenum, chromium, tin, zinc and palladium. The electrically-conductive material may be deposited using vacuum deposition, which includes (but is not limited to) evaporation (including thermal evaporation), sputtering, cathodic ion vaporisation, physical vapour depositions and chemical vapour deposition [CVD] (including low pressure CVD and plasma enhanced CVD). The electrically-conductive material may optionally be deposited by sputtering. The electrically-conductive material may optionally be deposited in an ink composition, for example by a printing technique.

When the electrically-conductive material is deposited in an ink composition, the electrically-conductive material may, for example, be present in the ink composition as metal nanoparticles (i.e. metal particles having a maximum dimension of 100 nm or less). The ink composition optionally further comprises a liquid vehicle, for example a solvent, which is typically removed after printing to leave a layer of electrically-conductive material. The liquid vehicle may optionally be a conductive vehicle.

Said electrode may comprise a supporting substrate to which has been adhered or otherwise attached a preformed layer of said electrically-conductive material. The preformed layer may optionally be in the form of a grid (i.e. a perforated layer).

One or both of the first electrode and the second electrode may optionally be provided with said electrically-conductive material. Advantageously, the first electrode may be provided with said electrically-conductive material.

The second electrode may optionally be provided with said electrically-conductive material.

Optionally, both the first and second electrode may be provided with said electrically-conductive material.

In accordance with a second aspect of the present invention, there is provided a photovoltaic cell array comprising a plurality of cells of the first aspect of the present invention, said plurality of cells being connected in series. The electrolyte of each cell may be isolated from contact with the electrolyte of neighbouring cells.

In accordance with a third aspect of the present invention, there is provided an electrode for use in the photovoltaic cell of the first aspect of the present invention. The electrode may comprise those features described above in relation to the photovoltaic cell of the first aspect of the present invention. For example, the electrode may be an anode or a cathode.

There is provided in accordance with a fourth aspect of the present invention, an electrode for a dye-sensitised photovoltaic cell, said electrode comprising an electrically-conductive material comprising (A) one or both of nickel and cobalt, and (B) one or more of phosphorous, boron, manganese, iron, tungsten, molybdenum, chromium, tin, zinc and palladium, the total content of (A) nickel and cobalt in said electrically-conductive material being from 80 to 96 wt % of the electrically-conductive material, and the total content of (B) phosphorous, boron, manganese, iron, tungsten, molybdenum, chromium, tin, zinc and palladium in said electrically-conductive material being from 4 to 20 wt % of the electrically-conductive material.

The electrode may be transparent. As mentioned above, this may be achieved by making the electrode from intrinsically transparent materials or by providing light-transmissive apertures in those materials which are not intrinsically transparent. For example, a certain thickness of said electrically-conductive material (for example, greater than 20 nm) may not be intrinsically transparent, but the provision of light-transmissive apertures in a layer of said material would make the layer transparent. A supported dye may be attached to the electrode. The electrode may optionally be reflective, for example. The electrode of the fourth aspect of the present invention may comprise those features described above in relation to the photovoltaic cell of the first aspect of the present invention.

In accordance with a fifth aspect of the present invention, there is provided a method of making an electrode for a dye-sensitised photovoltaic cell, the method comprising providing an electrode comprising a material comprising (A) one or both of nickel and cobalt, and (B) one or more of phosphorous, boron, manganese, iron, tungsten, molybdenum, chromium, tin, zinc and palladium,

the total content of (A) nickel and cobalt in said material being 80 to 96 wt % of the material, and the total content of (B) phosphorous, boron, manganese, iron, tungsten, molybdenum, chromium, tin, zinc and palladium in said material being from 4 to 20 wt % of the material.

The method may comprise:
(a) Providing a substrate; and
(b) Providing said substrate with said material comprising:
   (A) one or both of nickel and cobalt, and (B) one or more of phosphorous, boron, manganese, iron, tungsten, molybdenum, chromium, tin, zinc and palladium,
   the total content of (A) nickel and cobalt in said material being 80 to 96 wt % of the material, and the total content of (B) phosphorous, boron, manganese, iron, tungsten, molybdenum, chromium, tin, zinc and palladium in said material being from 4 to 20 wt % of the material.

In one embodiment, step (b) comprises providing a preformed layer of said material onto said substrate. For example, the preformed layer may comprise a perforated grid or a foil of said material. In another embodiment, step (b) comprises depositing said material onto said substrate, for example, by electrolytic deposition, electroless deposition, vacuum deposition or printing techniques. Vacuum deposition includes (but is not limited to) evaporation (including thermal evaporation), sputtering, cathodic ion vaporisation, physical vapour depositions and chemical vapour deposition [CVD] (including low pressure CVD and plasma enhanced CVD).

The substrate may have two or more surfaces for the deposition of said material (e.g. two faces), and step (b) may comprise depositing said material onto two or more surfaces of the substrate.

The method may comprise, subsequent to step (b), attaching the substrate to a further support.

The substrate may comprise an adhesion or tie layer onto which said material is attached. Therefore, the substrate may comprise a support and one or more layers attached the support.

In one embodiment, if the electrode comprises a support, the method may comprise forming the support from said material.

The method may comprise depositing one or more overlayers on said material. The one or more overlayers may comprise those features described above in relation to the photovoltaic cell of the first aspect of the present invention. For example, the one or more overlayers may comprise a protective layer. The method may therefore optionally comprise depositing a protective layer. The method may optionally comprise depositing a catalytic layer comprising catalyst. The method may optionally comprise depositing a protective layer and a catalytic layer comprising a catalyst. Optionally, the protective layer is deposited prior to the deposition of a catalytic layer. Alternatively, the catalytic layer may be deposited prior to the deposition of the protective layer. This may optionally be done by, for example, providing a dye-sensitized photovoltaic cell comprising the electrically-conductive material in intimate contact with the catalytic layer and with an electrolyte comprising sulphide ions and operating the photovoltaic cell. The electrically-conductive material may corrode to produce Ni²⁺ ions which react with sulphide ions to produce nickel sulphide over the electrically-conductive material.

As mentioned above in relation to the cell of the first aspect of the present invention, the protective layer may inhibit contact between the electrically-conductive material and a species with which the electrically-conductive material may react. The one or more overlayers may comprise a catalytic layer comprising a catalyst. The catalytic layer may comprise platinum or nickel Sulphide catalyst, for example. If the one or more overlayers comprises a catalytic layer, then optionally a protective layer may be provided between the catalytic layer and the electrically-conductive material. For example, if the catalytic layer comprises platinum catalyst, then it may be advantageous to provide a protective layer between the platinum-containing catalytic layer and the electrically-conductive material. It has been discovered that a protective layer may inhibit the corrosion of the electrically-conductive material which may occur if the electrically-conductive material is in contact with platinum.

The protective layer may optionally have a mean thickness of from 10 nm to 5 microns, and optionally a mean thickness of from 10 to 500 nm.

The protective layer may optionally comprise one or more metals selected from the group consisting of tantalum, tungsten, zirconium, niobium, molybdenum, titanium, ruthenium, rhodium, palladium, indium, rhenium, osmium, iridium and platinum. Such metals may be deposited by plasma vapour deposition (for example, for tantalum, tungsten, zirconium, niobium, molybdenum and titanium) and by electrochemical deposition (for example, for ruthenium, rhodium, palladium, indium, rhenium, osmium, iridium and platinum.)

The protective layer may optionally comprise one or more oxides, such as metal oxides or silicon oxide. The one or more oxides may be selected from the group consisting of silicon oxide, titanium dioxide, tin dioxide and indium tin oxide. Such protective layers may be deposited using chemical vapour deposition, such as atmospheric plasma assisted chemical vapour deposition.

The protective layer may optionally comprise one or more salts, optionally of nickel and/or cobalt, such as chromate, phosphate, molybdate, molybdophosphate, tungstate, permanganate, cerate, zirconate and sulphide. For example, optionally be protective layer comprises sulphide, such as nickel sulphide, cobalt sulphide and/or molybdenum sulphide. Sulphides may also provide an advantageous catalytic effect. Such protective layers may be formed chemically or electrolytically. For example, the protective layer may be formed on the electrically-conductive material prior to the assembly of the photovoltaic cell.

In accordance with a sixth aspect of the present invention, there is provided a method of protecting a substrate from corrosion comprising the step of forming a layer of a material onto the substrate, said material comprising (A) one or both of nickel and cobalt, and (B) one or more of phosphorous, boron, manganese, iron, tungsten, molybdenum, chromium, tin, zinc and palladium, the total content of (A) nickel and cobalt in said material being 80 to 96 wt % of the material, and the total content of (B) phosphorous, boron, manganese, iron, tungsten, molybdenum, chromium, tin, zinc and palladium in said material being from 4 to 20 wt % of the material.

In one embodiment of the sixth aspect of the invention, the substrate is a component of an electrode for use in a dye-sensitised photovoltaic cell, and the method is for protecting the electrode from corrosion by an electrolyte when the electrode is incorporated into a cell. The electrode protected in the method of the sixth aspect of the invention may, for example, be the electrode of the third aspect of the invention.

The layer of said material may be formed as described above in relation to the first, second, third, fourth and fifth aspects of the present invention.

The methods of the fifth and sixth aspects of the present invention may comprise those features described above in relation to the photovoltaic cell of the first aspect of the present invention.

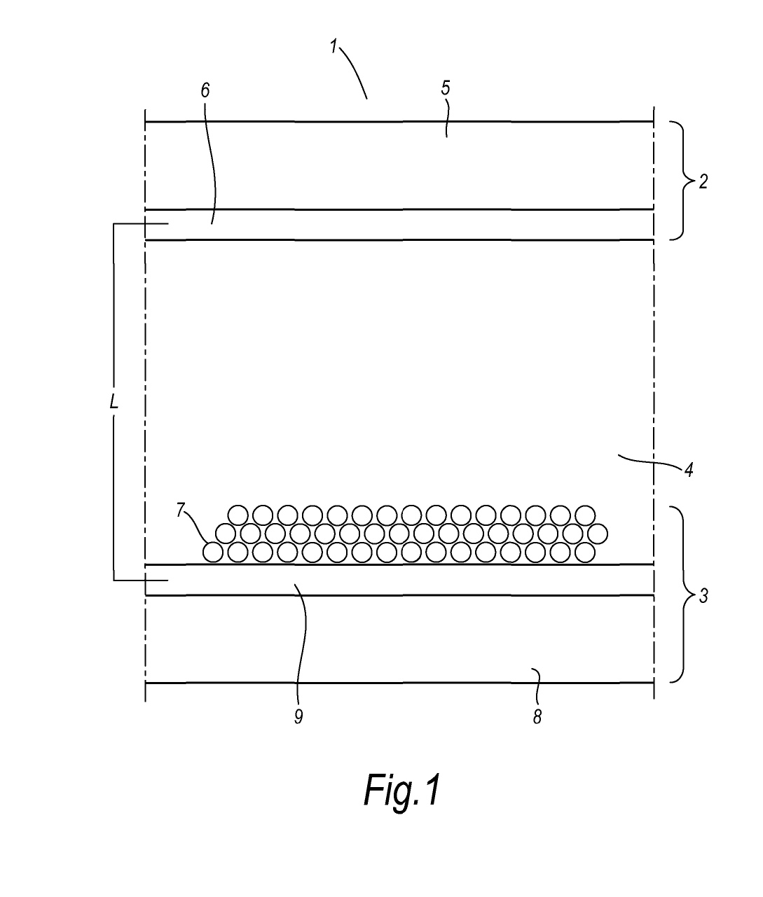

The invention will now be described by way of example only with reference to FIG. 1 which shows a schematic representation of a cross-section through a dye-sensitised photovoltaic cell 1.

The general structure of a dye-sensitised photovoltaic cell is well-known to those skilled in the art and is shown in FIG. 1. The cell 1 comprises a first electrode 2 spaced apart from a second electrode 3, electrolyte 4 being provided between the first and second electrodes. The electrodes are spaced apart by spacer elements (not shown) which are well-known to those skilled in the art and which prevent the electrodes from touching each other directly so as to cause a short. The first electrode 2 comprises an electrode supporting substrate 5 on which there rests a conductive material 6. The electrode supporting substrate 5 is transparent and is typically glass, although transparent polymers (such as polyethylene terephthalate or polyethylene naphthalate) may be used to form cells which are lightweight and/or flexible. The conductive material 6 is electrically conductive. The conductive material 6 is typically deposited onto the supporting substrate 5 by electrolytic or electroless coating methods (although those skilled in the art will realise that other methods may be used). The supporting substrate 5 may comprise one or more priming layers (not shown), for example, a thin layer of indium tin oxide or an adhesion enhancing treatment or coating (not shown), which facilitates deposition of the conductive material 6.

The second electrode 3 typically comprises an electrode support 8 and conductive material 9. The electrode support 8 is, in this case, transparent, but this is not necessarily so. For example, the electrode support 8 may be reflective so that light passing through the first electrode 2 and electrolyte 4 is reflected back into the cell. The electrode support 8 may be formed from a polymer if the cell is to be flexible.

The conductive material 9 is electrically conductive and is typically formed from a semiconductor material, such as indium tin oxide, although the conductive material 9 may be formed from a metal. The conductive material 9 forms a circuit with the rest of the cell as is described below.

A porous, dye-carrying support material 7 is attached to the second electrode 3. The porous, dye-carrying support material 7 typically comprises a layer of metal oxide particles (such as TiO₂ particles) which have been coated with a dye. The porous, dye-carrying support material 7 may, optionally, he a semi-conductor material. The metal oxide particles form a support of extremely high surface area for the dye and facilitate the flow of electrons from the dye to the electrode as will be described below. The layer of porous, dye-carrying support material is typically formed by depositing a layer of dye-free metal oxide onto the surface of the conductive material 9 and subsequently exposing the metal oxide layer to the dye.

The dye is well-known to those skilled in the art and is photosensitive, exposure to electromagnetic radiation above a certain frequency causing the formation of an excited state of the dye from which electron transfer may take place as described below. Ruthenium polypyridine is an example of such a dye.

The electrolyte 4 is located between the first and second electrodes 2, 3 and typically comprises an iodide solution. The electrolyte may be introduced into the cell by coating one or both of the electrodes with electrolyte and bringing the two electrodes together to form the cell 1. Alternatively, the electrodes may be brought together to form a cell (minus the electrolyte), and the cell (minus the electrolyte) filled with electrolyte by capillary action as is well-known to those skilled in the art.

The operation of the cell 1 of FIG. 1 is well-known to those skilled in the art but is summarised below for convenience. Electromagnetic radiation passes through the transparent supporting substrate 5 and conductive material 6 and is incident on the supported dye. Radiation having a sufficient frequency causes the dye to enter an excited state. An electron is “injected” from the excited state dye into the conductive band of the metal oxide (typically TiO₂). The electron migrates through the metal oxide to the conductive material 9, from which the electron may pass to an electrical load (L). Those skilled in the art will recognise that some electromagnetic radiation will be absorbed by the supporting substrate 5 and conductive material 6.

The electron-deficient dye gains an electron by reacting with the electrolyte. The electrolyte is typically I⁻ which, on reaction with the dye, forms triiodide (I₃⁻). This reaction is relatively quick and inhibits the recombination of the electron-deficient dye with the electron lost from the dye in its excited state.

The triiodide species migrates to the first electrode 2. Electrons are received by the first electrode 2 from load (L) and are reintroduced into the electrolyte 4. The triiodide species acquires these reintroduced electrons to form iodide (I⁻).

Those skilled in the art will recognise that the description above is an over-simplification. For example, the cell may comprise other layers or components not described.

Examples of coated substrates which may be used in improved electrodes of the present invention will now be described.

### EXAMPLE 1

A conductive material comprising nickel:phosphorous with 12 wt % phosphorous and 88 wt % nickel was deposited onto a brass substrate as follows,. A brass substrate was immersed in an aqueous solution containing a mixture of nickel salts (nickel sulphate and nickel chloride), phosphorous acid and boric acid, and nickel:phosphorous electroplated onto the brass substrate. The corrosion resistance of the conductive material was tested qualitatively using two methods well-known to those skilled in the art, these being (i) observation of the colour of the electrolyte and substrate on exposure of the substrate to the electrolyte and (ii) observation of the current-voltage cycling characteristics of a cell comprising the substrates mentioned above. Corrosion resistance was found to be good.

### EXAMPLE 2

A conductive material comprising cobalt:nickel:phosphorous with 12 wt % phosphorous, 53% nickel and 35 wt % cobalt was deposited onto a copper substrate as follows. A copper substrate was immersed in an aqueous solution containing a mixture of nickel salts (nickel sulphate and nickel chloride), cobalt sulphate, phosphorous acid and boric acid, and the cobalt:nickel:phosphorous electroplated onto the copper substrate. The corrosion resistance was assessed as described above in relation to Example 1 and the corrosion resistance was found to be good.

### EXAMPLE 3

A conductive material comprising nickel phosphorous with 8 wt % phosphorous and 92 wt % nickel was deposited onto a polyethylene terephthalate (PET) substrate as follows. The PET foil was degreased and activated with a tin-palladium catalyst. A nickel:phosphorous underlayer was then deposited using an electroless method. A layer of nickel is deposited thereon using an electrolytic process. A conductive upper layer of nickel:phosphorous (with 8 wt % phosphorous) was subsequently deposited using an electrolytic process by deposition out of an aqueous solution containing a mixture of nickel salts (nickel sulphate and nickel chloride), phosphorous acid and boric acid.

### EXAMPLE 4

A conductive material comprising nickel:phosphorous with 6 wt % phosphorous and 94 wt % nickel was deposited onto a glass substrate as follows. The glass substrate was degreased and activated with a tin-palladium catalyst. A nickel:phosphorous underlayer was then deposited using an electroless method. A conductive upper layer of nickel:phosphorous was subsequently deposited using an electroless method out of an aqueous solution containing a mixture of nickel salts (nickel sulphate and nickel chloride), sodium hypophosphite and citric acid.

### EXAMPLE 5

A conductive material comprising cobalt:phosphorous with 10.5 wt % phosphorous was deposited onto a polyethylene terephthalate (PET) substrate coated with a seed layer of ITO (indium-tin-oxyde) as follows. The PET/ITO foil was degreased and a cobalt:phosphorous layer was then deposited thereon using an electrolytic process out of an aqueous solution containing a mixture of cobalt salts (cobalt sulphate and cobalt chloride), phosphorous acid and boric acid.

The Examples below demonstrate how one or more overlayers may be deposited onto the electrically-conductive material. The one or more overlayers often comprises a protective layer which helps resist corrosion of the electrically-conductive material. This may be desirable, for example, if the electrically-conductive material is susceptible to corrosion. Slow corrosion has been observed to occur when platinum catalyst comes into contact with the electrically-conductive material. This is sometimes observed when a platinum catalyst is deposited directly onto the electrically-conductive material or when the platinum is provided on the counter-substrate to the electrically-conductive material, but the electrically-conductive material is in intimate contact with the electrolyte.

### EXAMPLE 6

A 20 micron thick layer of NiP (12 wt % phosphorus) was electroformed on a stainless steel mandrel in a commercial electroless nickel bath to form a NiP foil [hereinafter called “NiP12 foil”]. After detachment from the mandrel, the NiP12 foil was coated with a 50 nm think tantalum layer using plasma vapour deposition. The coated foil was then immersed in an iodine/iodide electrolyte and connected to a platinum counter-electrode. The electrical corrosion current resulting from the short-circuited cell was measured and found to be eight times lower than the corrosion current generated using a NiP foil without the protective tantalum layer. The thickness of the tantalum layer was determined using a quartz oscillator as it well known to those skilled in the art.

### EXAMPLE 7

A NiP12 foil (made as indicated above in Example 6) was coated with a 20 nm thick molybdenum layer using plasma vapour deposition. The coated foil was immersed in an iodine/iodide electrolyte and connected to a platinum counter-electrode. The electrical corrosion current resulting from the short-circuited cell was measured and found to be five times lower than the corrosion current generated using a NiP foil without the protective molybdenum layer. The thickness of the molybdenum layer was determined using a quartz oscillator as it well known to those skilled in the art.

### EXAMPLE 8

A NiP12 Foil (made as indicated above in Example 6) was coated with 50-100 nm thick layer of tin dioxide using atmospheric plasma assisted chemical vapour deposition. The coated foil was then electrolytically platinized in a solution containing hexachloroplatinic acid, and then immersed in an iodine/iodide electrolyte and submitted to cyclic voltammetry measurements. The coated foil was then thermocycled from room temperature to 80° C. ten times. The coated foil was then submitted to further cyclic voltammetry measurements. No degradation of the charge transfer activity could be observed after thermal cycling, showing an excellent protection efficiency of the tin dioxide layer. Reference probes may be used to determine the thickness of the tin dioxide layer.

### EXAMPLE 9

A grid comprising a coating of NiP (12 wt % phosphorus) (10 microns thick, 500 microns mesh and 90% opening) was electrolytically coated with a 100 nm thick ruthenium layer. The coated grid was then cathodically top coated with a platinum catalyst using a hexachloroplatinic acid solution. The platinum deposit, under SEM observation, had the morphology of discontinuous nanoflowers and the amount deposited was equivalent to a 5 nm thick layer. The coated grid was then immersed in an iodine/iodide electrolyte and submitted to cyclic voltammetry measurements. The coated grid was then thermocycled from room temperature to 80° C. ten times. The coated grid was then submitted to further cyclic voltammetry measurements. No degradation of the charge transfer activity could be observed after thermal cycling, showing an excellent protection efficiency of the ruthenium layer.

### EXAMPLE 10

A NiP12 foil (made as indicated above in Example 6) was degreased and activated (deoxidised) in HCl 1:1 for three minutes. The treated foil was then immersed in a 0.5M molybdate-containing solution for ten minutes. The coated foil was then immersed in an iodine/iodide electrolyte and connected to a platinum counter-electrode. The electrical corrosion current resulting from the short-circuited cell was measured and found to be eight times lower than the corrosion current generated using a NiP foil without the protective molybdate layer.

### EXAMPLE 11

A grid comprising a coating of NiP (12 wt % phosphorus) (10 microns thick, 200 microns mesh and 90% opening) was cathodically coated with a platinum catalyst in a hexachloroplatinic acid solution. The platinum deposit, under SEM observation, had the morphology of discontinuous nanoflowers and the amount deposited was equivalent to a layer thickness of 5 nm. The coated grid was then immersed in an iodine/iodide electrolyte containing 5 mM sodium hydrogen sulphide. The electrode was submitted to cyclic voltammetry measurements which were repeated after ten times thermocycling at 80° C. No degradation of the charge transfer activity could be observed after thermal cycling, showing an excellent protection efficiency of a sulphide-containing overlayer forming on the surface of the NiP/Pt. The presence of a sulphide overlayer is indicated by the dark colouring of the coated grid.

Examples 6 to 11 above demonstrate how a protective layer can be formed over the electrically-conductive material. It is also possible for there to be an overlayer on the electrically-conductive material which does not operate as a protective layer. For example, if the overlayer comprises nickel sulphide, then this layer may act as a catalyst as is exemplified below.

### EXAMPLE 12

A NiP12 foil was degreased and then activated in HCl 1:1 for three minutes. The treated foil was then immersed in a 0.5M sodium hydrogen sulphide-containing solution and anodically polarised for five minutes at 0.5 A/cm². The NiP foil was covered with a dark passivating sulphide film. The coated foil was then immersed in an iodine/iodide electrolyte and submitted to cyclic voltammetry measurements. It could be observed that the NiP—S electrode had excellent charge transfer properties, in the same order of magnitude as the platinised electrodes. The coated foil was thermocycled at 80° C. ten times and the cyclic voltammetry measurements repeated. No degradation of the charge transfer activity could be observed after thermal cycling.

The weight percentages of the components of the conductive material were determined using energy-dispersive x-ray spectroscopy (EDX).

The coated substrates described above may be used in one or both of the anode and the cathode of a dye-sensitised photovoltaic cell.

Where, in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A dye-sensitised photovoltaic cell comprising a first, transparent, electrode facing a second electrode, wherein at least one of the first and second electrodes is provided with an electrically-conductive material comprising (A) one or both of nickel and cobalt, and (B) one or more of phosphorous, boron, manganese, iron, tungsten, molybdenum, chromium, tin, zinc and palladium,
wherein the total content of (A) the nickel and cobalt in said electrically-conductive material is from 80 to 96 wt % of the electrically-conductive material, and total content of (B) the phosphorous, boron, manganese, iron, tungsten, molybdenum, chromium, tin, zinc and palladium in said electrically-conductive material is from 4 to 20 wt % of the electrically-conductive material.

2. A cell according to claim 1 in which the wt % of the electrically-conductive material which is not nickel, cobalt, phosphorous, boron, manganese, iron, tungsten, molybdenum, chromium, tin, zinc or palladium is from 0 to 2 wt %.

3. (canceled)

4. A cell according to claim 1 in which the total content of phosphorous, boron, manganese, iron, tungsten, molybdenum, chromium, tin, zinc and palladium is at least 7 wt % of the electrically-conductive material.

5. (canceled)

6. A cell according to claim 1 in which the electrically-conductive material is amorphous.

7. A cell according to claim 1 wherein component (A) of the electrically conductive material is nickel alone, with no cobalt.

8. A cell according to claim 1 wherein component (A) of the electrically conductive material is cobalt alone, with no nickel.

9. A cell according to claim 1 wherein component (A) of the electrically conductive material is nickel and cobalt.

10. (canceled)

11. A cell according to claim 1 in which the electrically-conductive material comprises only one or two of phosphorous, boron, manganese, iron, tungsten, molybdenum, chromium, tin, zinc and palladium.

12. (canceled)

13. A cell according to claim 1 in which component (B) comprises phosphorous.

14. A cell according to claim 1 in which the electrically-conductive material is in the form of a layer.

15. A cell according to claim 14 in which the layer has a thickness of up to 200 μm.

16. A cell according to claim 1 further comprising an electrolyte, in which the electrically-conductive material is arranged to be in contact with the electrolyte.

17. A cell according to claim 1 comprising one or more layers overlying the electrically-conductive material, said one or more layers being porous.

18. A cell according to claim 1 wherein an electrode comprising the electrically-conductive material comprises a supporting substrate and an activation layer provided between the supporting substrate and the electrically-conductive material.

19-20. (canceled)

21. A cell according to claim 1, wherein an electrode comprises the electrically-conductive material comprising a supporting substrate and a layer of metal is provided between the supporting substrate and the electrically-conductive material.

22. (canceled)

23. A cell according to claim 1 wherein the electrically-conductive material is deposited using an electroless method, an electrolytic method, vacuum deposition or in an ink composition.

24-27. (canceled)

28. A cell according to claim 1 wherein both the first and second electrodes are provided with said
electrically-conductive material.

29. A cell according to claim 1 comprising one or more overlayers provided on the electrically-conductive material.

30. A cell according to claim 29 wherein the one or more overlayers comprise a protective layer or a catalytic layer or both comprising a catalyst.

31. (canceled)

32. A cell according to claim 30 wherein a protective layer is provided between the catalytic layer and the electrically-conductive material.

33-34. (canceled)

35. A cell according to claim 30, the protective layer comprising:
(i) one or more metals selected from the group consisting of tantalum, tungsten, zirconium, niobium, molybdenum, titanium, ruthenium, rhodium, palladium, indium, rhenium, osmium, iridium and platinum; or
(ii) one or more oxides selected from the group consisting of silicon oxide, titanium dioxide, tin dioxide and indium tin oxide; or
(iii) one or more salts are selected from the group consisting of chromate, phosphate, molybdate, molybdophosphate, tungstate, permanganate, cerate, zirconate and sulphide.

36-39. (canceled)

40. A photovoltaic cell array comprising a plurality of cells according to claim 1, said plurality of cells being connected in series.

41-42. (canceled)

43. An electrode for a dye-sensitised photovoltaic cell, said electrode comprising an electrically-conductive material comprising (A) one or both of nickel and cobalt, and (B) one or more of phosphorous, boron, manganese, iron, tungsten, molybdenum, chromium, tin, zinc and palladium, the total content of (A) nickel and cobalt in said electrically-conductive material being from 80 to 96 wt % of the electrically-conductive material, and the total content of (B) phosphorous, boron, manganese, iron, tungsten, molybdenum, chromium, tin, zinc and palladium in said electrically-conductive material being from 4 to 20 wt % of the electrically-conductive material.

44-46. (canceled)

47. A method of making an electrode for a dye-sensitised photovoltaic cell, the method comprising providing an electrode comprising a material comprising (A) one or both of nickel and cobalt, and (B) one or more of phosphorous, boron, manganese, iron, tungsten, molybdenum, chromium, tin, zinc and palladium, the total content of (A) nickel and cobalt in said material being 80 to 96 wt % of the material, and the total content of (B) phosphorous, boron, manganese, iron, tungsten, molybdenum, chromium, tin, zinc and palladium in said material being from 4 to 20 wt % of the material.

48-53. (canceled)

54. A method of protecting a substrate from corrosion comprising the step of forming a layer of a material onto the substrate, said material comprising (A) one or both of nickel and cobalt, and (B) one or more of phosphorous, boron, manganese, iron, tungsten, molybdenum, chromium, tin, zinc and palladium, the total content of (A) nickel and cobalt in said material being 80 to 96 wt % of the material, and the total content of (B) phosphorous, boron, manganese, iron, tungsten, molybdenum, chromium, tin, zinc and palladium in said material being from 4 to 20 wt % of the material.

55. A cell according to claim 15, wherein the layer has a thickness of from 1 to 10 μm.
